(19) United States
(12) Patent Application Publication
(10) Pub. No.: US 2009/0190586 A1
(43) Pub. Date: Jul. 30, 2009

(54) METHOD AND SYSTEM FOR VOTING OPTIMAL ROUTE IN MULTICASTING

(76) Inventor: Yong-Hwa Kim, Incheon-shi (KR)

Correspondence Address: DICKSTEIN SHAPIRO LLP, 1825 EYE STREET NW, Washington, DC, 20006-5403, US

(21) Appl. No.: 12/089,525

(22) PCT Filed: Oct. 6, 2005
(86) PCT No.: PCT/KR2005/003302

§ 371 Date: Aug. 21, 2008

(51) Int. Cl. H04L 12/56

(52) U.S. Cl. 370/390

(57) ABSTRACT

The present invention relates generally to multicasting technology in an Internet broadcasting system and, more particularly, to a method and system for voting an optimal route in multicasting, which, when an abnormality, such as the delay or disconnection of a video stream, occurs during the reception of a predetermined or larger amount multimedia data which is multicasted by a main server, in stream form, set the specific one of a plurality of audio transmission routes, that has the highest transmission speed, as a video transmission route, and set the transmission route through a level-down, level-up, or level-shift operation depending on the latency values or threshold values of respective transmission routes, thus allowing a large size multimedia stream to be seamlessly and rapidly transmitted.

In accordance with the present invention, it is possible to always prepare an optimal transmission route and stably and rapidly transmit a multimedia stream. Furthermore, when an abnormality occurs in the reception of a video stream, the specific one of a plurality of audio transmission routes, which has the highest transmission speed, is set as a video reception route, so that it is possible to continuously receive the video stream without delay or disconnection.

### FIELD OF THE INVENTION

The present invention relates generally to multicasting technology in an Internet broadcasting system and, more particularly, to a method and system for voting an optimal route in multicasting, which, when an abnormality, such as the delay or disconnection of a video stream, occurs during the reception of a predetermined or larger amount of multimedia data which is multicasted by a main server, in stream form, set the specific one of a plurality of audio transmission routes, that has the highest transmission speed, as a video transmission route, and set the transmission route through a level-down, level-up, or level-shift operation based on the latency values or threshold values of respective transmission routes, thus allowing a large size multimedia stream to be seamlessly and rapidly transmitted.

### BACKGROUND

As it is very difficult to modify the construction of a router, in Internet transmission, a multicast method has been developed in which a client, which receives data from a transmitter as Unicast, uploads, and relays the received data, thus allowing other clients to receive the data, without requiring modification to a router at all.

FIG. 1 is a conceptual diagram of a multicast network employing a conventional peer-to-peer transmission method.

As shown in FIG. 1, in the multicast method, when data, which has been received from the data transmission server 107 of a network 110, in which a data source 105 exists, by a network 130 to which a client 134 belongs, is uploaded again, the other clients 136 and 138 of the network 130 receive the data from the client 134. That is, when receiving data, a relay client belonging to a network functions as a repeater and thus can transmit the data to other clients on the same network. In this case, a program for performing a relay function is installed in the relay client such that the multimedia stream is transmitted to other clients using the program.

Meanwhile, other clients that receive the multimedia stream through a relay client must select the relay client having the transmission route having the highest speed in order to receive a large size multimedia stream. General methods of finding the transmission route having the highest speed include a “Nearest” method of passing data through the lowest number of routers, and a “Fastest” method of checking response speeds by transmitting “Ack” signals and finding a route having the highest response speed.

The “Nearest” method is a method of establishing the route that employs the lowest number of routers, through routers connected to a media server, and streaming data. In this case, provided that the number of routers is decreased, thereby decreasing load, and the speeds of the routers are high, desired streaming based on the rapid data transmission is provided. However, since the streaming speed based on data transmission is not absolutely proportional to the number of routers (the number of hops), it may be more efficient to establish a route using four routers having high speed, and transmit data in that way than to pass data through three routers having low speed.

The “Fastest” method is a method of selecting only the quickly responding routers among routers connected to the media server, establishing a route using only the selected routers, and relaying data. This case is advantageous in that it has more reliable and rapid data transmission speed than the “Nearest” method.

However, the “Fastest” method is not always absolute because it may not be suitable for transmitting a large amount of data even though the response speed is high. That is, because the transmission capability varies depending on the bandwidth, transmitting a large amount of data at high response speed and a small bandwidth cannot always be more suitable than transmitting it at large bandwidth. Furthermore, the set route is not absolute because the speed of a network is variable with time.

Accordingly, the present invention has been made keeping in mind the above problems occurring in the prior art, and an object of the present invention is to provide a method and system for voting an optimal route in multicasting, which, when an abnormality, such as the delay or disconnection of a video stream, occurs during the reception of a predetermined or larger amount of multimedia data, which is multicast by the main server, in stream form, set the specific one of a plurality of audio transmission routes, which has the highest transmission speed, as a video transmission route, and set the transmission route through a level-down, level-up, or level-shift operation based on the latency values or threshold values of respective transmission routes, thus allowing a large multimedia stream to be seamlessly and rapidly transmitted.

### SUMMARY

In order to accomplish the above objects, the present invention provides a system for voting an optimal route, which most rapidly and stably receives multimedia streams multicast from the main server, including relay-type broker terminals for initially receiving the multimedia streams multicast from the main server and relaying them to terminals at a junior level; voting-relay-type broker terminals for receiving a video stream from one relay-type broker terminal directly connected thereto and audio streams from remaining relay-type broker terminals, and, when an abnormality occurs in the reception route of the video stream, comparing reception amounts and transmission speeds of the respective audio transmission routes, voting a specific one of the audio transmission routes that has the highest speed, setting the voted route as a new video transmission route, and relaying the received multimedia streams to a terminal at a junior level; and voting-type broker terminals for receiving the multimedia streams from the voting-relay-type broker terminals, receiving the video stream from one voting-relay-type broker terminal directly connected thereto and the audio streams from remaining voting-relay-type broker terminals, and when an abnormality occurs in the transmission route of the video stream, voting a specific one of the audio transmission routes that has the highest speed, setting the one as a new video transmission route, and receiving the video stream.

Furthermore, the present invention provides a method of voting an optimal route in a system having voting-relay-type broker terminals for receiving multimedia streams from the main server through relay-type broker terminals and relaying the multimedia streams to a terminal at a junior level, and voting-type broker terminals for receiving the multimedia streams relayed by the voting-relay-type broker terminals, including a first step of receiving the multimedia streams comprising video and audio from the main server through transmission routes; a second step of comparing reception amounts and transmission speeds of respective audio transmission routes and storing the transmission routes in senior list and junior list; a third step of determining whether an abnormality, including a delay or disconnection, has occurred in reception of a video stream; a fourth step of calculating an average latency value of the video transmission route, increasing a flag value and determining whether the flag value has exceeded a predetermined threshold value to determine whether a single transmission route is abnormal or overall transmission routes are abnormal; and a fifth step of, when the flag value has exceeded a predetermined threshold value, comparing reception amounts and transmission speeds of respective audio transmission routes, voting a route having a highest transmission speed and setting the voted route as a video stream reception route.

In accordance with the present invention, it is possible to always prepare an optimal transmission route and stably and rapidly transmit a multimedia stream. Furthermore, when an abnormality occurs in the reception of a video stream, the specific one of a plurality of audio transmission routes, which has the highest transmission speed, is set as a video reception route, so that it is possible to continuously receive the video stream without delay or disconnection.

In a process of setting an optimal route having the highest speed, a level-up, level-down or level-shift operation may be performed on a transmission route depending on the latency values of respective transmission routes.

Furthermore, there is an advantage in that, if the delay of data continues for a predetermined time interval while frequently occurring traffic situations are automatically monitored, switching to the specific one of a plurality of relay candidates having the next optimal route is performed, thereby maximally ensuring the continuity of data transmission.

### BRIEF DESCRIPTION OF THE DRAWINGS

FIG. 1 is a conceptual diagram of a multicast network employing a conventional peer-to-peer transmission method;

FIG. 2 is a diagram schematically illustrating the construction of a system for voting an optimal route in multicasting according to an embodiment of the present invention;

FIG. 3 is a diagram schematically illustrating the internal construction of the relay-type broker terminal 220;

FIG. 4 is a diagram schematically illustrating the internal construction of the voting-relay-type broker terminal 230;

FIG. 5 is a flowchart illustrating a process of performing a level-down operation on a transmission route when an abnormality occurs in the transmission route between a senior parent terminal and a junior child terminal in the method of voting an optimal route in multicasting according to the embodiment of the present invention;

FIG. 6 is a flowchart illustrating a process of performing a level-up operation on a transmission route when an abnormality occurs in the transmission route between a senior parent terminal and a junior child terminal, in the method of voting an optimal route in multicasting according to the embodiment of the present invention; and

FIG. 7 is a flowchart illustrating a process of performing a level-shift operation on a transmission route when an abnormality occurs in the transmission route between a senior parent terminal and a junior child terminal, in the method of voting an optimal route in multicasting according to the embodiment of the present invention.

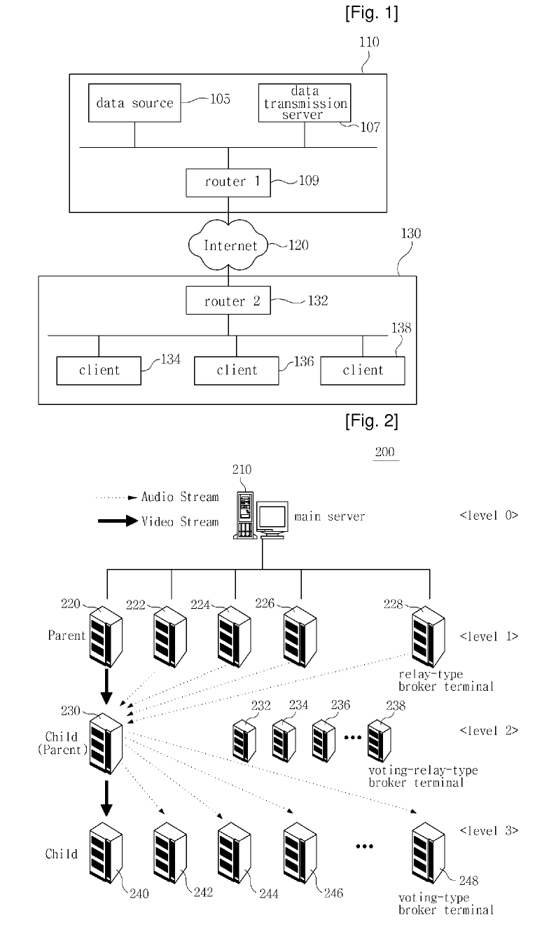

### DESCRIPTION OF REFERENCE CHARACTERS OF PRINCIPAL ELEMENTS

105: data source
107: data transmission server
109: router 1
110: data source side network
120: Internet
130: client side network
132: router 2
134˜138: client
200: system for voting optimal route
210: main server
220˜228: relay-type broker terminal
230˜238: voting-relay-type broker terminal
240˜248: voting-type broker terminal
310: connection information management unit
320: data transmission and reception control unit
330: media-channel management unit
340: junior list management unit
350: data transmission unit
410: data reception unit
420: senior list management unit

### DETAILED DESCRIPTION OF THE INVENTION

Preferred embodiments of the present invention will be described in detail below with reference to the accompanying drawings.

It should be noted that, in the assignment of numerical references to the elements of respective drawings, the same elements have the same numerical reference even when represented in different drawings.

Furthermore, with respect to the descriptions of the present invention, detailed descriptions of related known prior art constructions and functions are omitted when they are deemed to obscure the subject matter of the present invention.

First, to help understand the present invention, the basic concept of the present invention and the term “voting” disclosed in the following embodiments are described.

In the present invention, terminals which initially receive a multimedia stream transmitted from the main server (Dispatcher: Cast 365 Plus Server) and relay the stream to terminals at a junior level are referred to as level 1 parent terminals, and a terminal which receives the multimedia stream through the level parent terminal is referred to as a level 2 child terminal.

Furthermore, when a level 2 child terminal receives a multimedia stream from a level 1 parent terminal and relays the multimedia stream to a level 3 terminal at a junior level, the level 2 child terminal becomes a level 2 parent terminal, and the terminal which receives the multimedia stream via the level 2 parent terminal becomes a level 3 child terminal.

The level 1 parent terminal which receives the multimedia stream from the main server through an optimal route and transmits it to the junior level 2 terminal, and the level 2 child terminal which receives the multimedia stream from the level 1 parent terminal via a voted route and transmits it to the junior level 3 terminal are referred to as “broker terminals” in the sense that they receive the multimedia stream and relay it to terminals at a junior level.

Meanwhile, the present invention is configured to always find an optimal relay candidate by continuously receiving data, which is a large amount of audio data that is the second largest among several pieces of data constituting a transmission stream including video data and audio data, through about 10 relay candidates and maintaining a list thereof while updating the states of the candidates in a multimedia transmission relay system having a tree structure. In this case, the number of candidates may be freely adjusted in a setting file.

At this time, an operation of comparing the “reception amounts” and “transmission speeds” of the list of relay candidates, which currently receive audio data packets, with each other, and setting an excellent audio route having the uppermost value, that is, the highest transmission speed, as a video transmission route, when a connection delay or disconnection of a video stream occurs during the reception thereof, is referred to as ‘voting’.

As a result, a level 1 broker terminal unilaterally receives a multimedia stream from the main server and relays and transmits the multimedia stream to junior level 2 broker terminals, and, thus, the level 1 broker terminal has a stressed relay function, so that the level 1 broker terminal is referred to as a “relay-type broker terminal”.

Furthermore, a level 2 broker terminal receives a multimedia stream via the route having the highest transmission speed from the senior level 1 parent terminal through a voting process, and relays and transmits the multimedia stream to a junior level 3 broker terminal based on a relay function, so that the level 2 broker terminal is referred to as a “voting-relay-type broker terminal” performing both relay and voting functions.

Furthermore, a level 3 broker terminal is a broker terminal at a final level and only receives a multimedia stream via a voted route without performing a relay function, so that the level 3 broker terminal is referred to as a “voting-type broker terminal” in which a voting function is stressed.

As described above, when receiving a multimedia stream from a broker terminal at a senior level, a terminal becomes a child terminal. When a terminal is currently a child terminal, but relays a received multimedia stream to a broker terminal at a junior level, the terminal is a parent terminal at the corresponding level. This is identically applicable to N-level transmission routes.

It is noted that, in an embodiment of the present invention, 3-level transmission routes are described as an example, but it can be identically applicable to N-level transmission routes.

FIG. 2 is a diagram schematically illustrating the construction of a system 200 for voting an optimal route in multicasting according to an embodiment of the present invention. The system 200 for voting an optimal route according to an embodiment of the present invention includes a main server (dispatcher) 210, relay-type broker terminals 220 to 228, voting-relay-type broker terminals 230 to 238, and voting-type broker terminals 240 to 248.

The main server 210 is a ‘Cast 365 Plus Server’ and multicasts broadcasting multimedia data, including a moving image, video and audio, in stream form.

The relay-type broker terminals 220 to 228 initially receive the multimedia stream multicast by the main server 210, perform tunneling on client terminals and broker terminals at a junior level connected to a network through a multicasting router, and relay and transmit the multimedia stream. That is, the relay-type broker terminals 220 to 228 are specific ones among multimedia transmission broker terminals in which a “relay function” is emphasized.

An optimal route voting program is installed in the voting-relay-type broker terminals 230 to 238. The voting-relay-type broker terminals 230 to 238 receive a video stream from the relay-type broker terminal 220 directly connected thereto and audio streams from the remaining relay-type broker terminals 222 to 228. The voting-relay-type broker terminals 230 to 238 select a specific one from among audio transmission routes, which has the highest transmission speed, as a video transmission route through the above-described voting process in the case where an abnormality occurs in the transmission route of the video stream, receive the video stream, and relay the multimedia stream received from the relay-type broker terminals to the voting-type broker terminals 240 to 248 at a junior level.

An optimal route voting program is installed in the voting-type broker terminals 240 to 248. The voting-type broker terminals 240 to 248 receive multimedia streams from the voting-relay-type broker terminals 230 to 238 through a multicasting router. In detail, the voting-type broker terminals 240 to 248 receive a video stream from the voting-relay-type broker terminal 230 directly connected thereto and audio streams from the remaining voting-relay-type broker terminals 232 to 238. The voting-type broker terminals 240 to 248 select a specific one from among the audio transmission routes, which has the highest transmission speed, as a video transmission route through the above-described voting process in the case where an abnormality in the transmission route of the video stream, and receive the video stream.

A multicasting relay program is installed in the main server. The main server 210 provides a multicasting relay program and a program for performing a relay function of conducting communication between respective client terminals, to respective client terminals via download. The program for performing the relay function, which is downloaded from the main server, is installed in the voting-relay-type broker terminals 230 to 238 and the voting-type broker terminals 240 to 248.

The program for performing the relay function communicates with the multicasting relay program, which is installed in the main server 210, in a peer-to-peer manner via a plurality of multicasting routes, and receives the multimedia stream transmitted from the main server 210.

FIG. 3 is a diagram schematically illustrating the internal construction of the relay-type broker terminal 220.

As illustrated in FIG. 3, the relay-type broker terminal 220 includes a connection information management unit 310 for storing information about the levels of targets to be connected and information about the transmission speeds of current connections for transmitting multimedia streams; a data transmission and reception control unit 320 for processing various types of messages needed for data transmission and latency control, and functioning to control dynamic routing (processed when maxAccumLatency is reached); a media-channel management unit 330 for managing connections for respective channels (substreams); a junior list management unit 340 for storing information about a list of routes through which multimedia streams are transmitted to the terminals at a junior level; and a data transmission unit 350 for transmitting multimedia streams to the outside.

The data transmission unit 350 examines connections to the child terminals at a junior level and causes dynamic routing to be achieved.

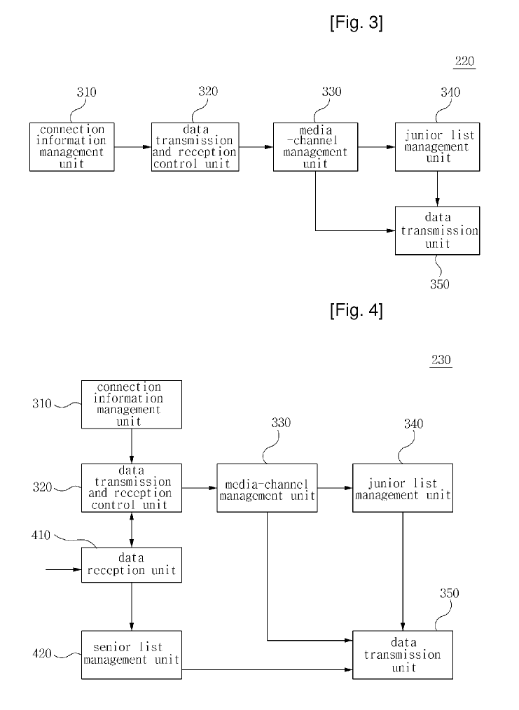

FIG. 4 is a diagram schematically illustrating the internal construction of the voting-relay-type broker terminal 230.

The voting-relay-type broker terminal 230 has a construction in which a data reception unit 410 for receiving the multimedia streams transmitted from the relay-type broker terminal 220, and a senior list management unit 420 for storing transmission route list information for the reception of multimedia streams from the terminals at a senior level are added to the internal elements of the relay-type broker terminal 220.

The junior list management unit 340 and the senior list management unit 420 store a plurality of audio transmission routes, besides the video transmission routes, compare the transmission speeds of audio streams calculated using the following Equation 1, arranges the audio transmission speeds in descending order, and stores them.

Audio transmission speed=packet size*256/(current time-packet transmission time)/the total number of child terminals (1)

As a result, at the time of a new connection, the junior list management unit 340 and the senior list management unit 420 compare the speed of the new connection with the speeds of the existing connections, arrange the transmission speeds in descending order, and update the list.

When a connection delay or disconnection occurs during the reception of the multimedia stream, the data reception unit 410 reads out the uppermost value (the fastest value) from the current list of the senior list management unit 420, and sets the corresponding route as a transmission route. Furthermore, the candidate route list is updated, with a transmission speed value of the transmission route set as a connection route being decreased by half.

The operation of the optimal route voting system 200 according to the embodiment of the present invention constructed as described above is described below.

In the embodiment of the present invention, the term ‘latency’ refers to the transmission delay of a packet between a level 1 parent terminal and a level 2 child terminal. Furthermore, the term ‘Receive Latency’ refers to the difference between the time at which the child terminal might receive the packet and the time at which the child terminal actually received the packet. The term ‘Send Latency’ refers to the difference between the time at which the packet might be transmitted and the time at which the packet is actually transmitted. Furthermore, the term ‘Accumulate Latency’ refers to the accumulated value of the latency. When this Accumulate Latency exceeds a predetermined value, a dynamic routing is performed.

Meanwhile, in the present invention, the senior list is a list of broker terminals which transmit a multimedia stream to a child terminal, and the junior list is a list of broker terminals which receive a multimedia stream from a parent terminal.

Accordingly, from the viewpoint of the child terminal, when a broker terminal performs a ‘level-down’ operation, a newly connected parent terminal requests a junior list from the parent terminal of the child terminal, acquires it and transmits it to the newly connected child terminal. In this case, the junior list becomes a senior list for the child terminal.

Furthermore, audio packets for senior and junior connections are transmitted by stream connection in order of early responding packet.

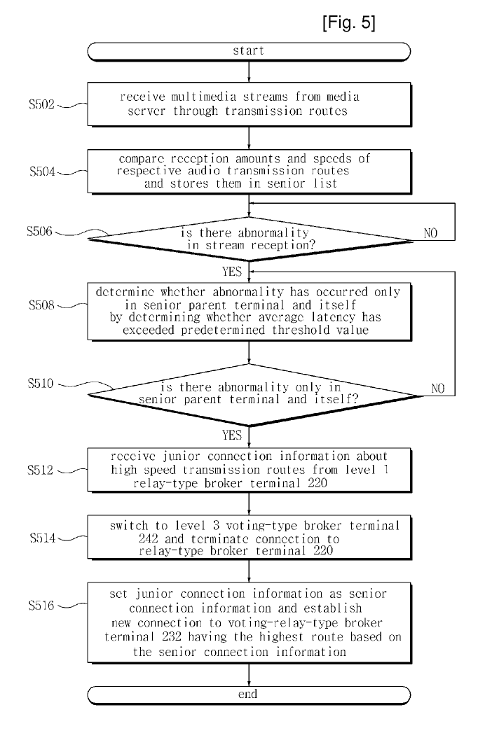

FIG. 5 is a flowchart illustrating a process of performing a level-down operation on a transmission route, in the method of voting an optimal route in multicasting according to the embodiment of the present invention.

First, the term ‘level-down operation’ refers to a method in which the voting-relay-type broker terminal 230 performs a level-down operation on the route if an abnormality occurs in the transmission route to the relay-type broker terminal 220 during the reception of a multimedia stream from the relay-type broker terminal 220 at a senior parent level.

The voting-relay-type broker terminal 230 at a child level receives multimedia streams from the main server 210 through the relay-type broker terminal 220 at a parent level. The voting-relay-type broker terminal 230 at a child level receives a video stream from the first relay-type broker terminal 220 and an audio stream from the remaining other relay-type broker terminals 222 to 228 at step S502.

The voting-relay-type broker terminal 230, which operates as a child terminal, compares the transmission amounts and speeds of respective audio transmission routes, through which sub-streams are received, with each other, and stores and manages the routes in descending order of route quality and in list form in the senior list management unit 420 at step S504.

Thereafter, the voting-relay-type broker terminal 230 determines whether there is an abnormality, such as a delay or disconnection, during the reception of the multimedia stream at step S506.

If an abnormality occurs during the reception of the multimedia stream, the voting-relay-type broker terminal 230 acquires latencies of all audio stream transmission routes as well as a video stream transmission route and calculates the average of the latencies. Then the voting-relay-type broker terminal 230 increases a flag value (DownCount) and determines whether the flag value has exceeded a predetermined threshold value, thereby determining whether the abnormality has occurred only in a senior parent terminal and itself, or in all reception routes, at step S508. In this case, if the number of the abnormal routes is equal to or more than half of the number of all the transmission routes, the entire situation is considered to be undesirable.

When it is determined that the abnormality has occurred between the relay-type broker terminal 220 at the parent level and the voting-relay-type broker terminal 230 at the child level (S510), the voting-relay-type broker terminal 230 at the child level receives junior connection information about high speed transmission routes from the relay-type broker terminal 220 at level 1 at step S512. That is, when the abnormality has occurred in transmission to terminals at a junior child level, the relay-type broker terminal 220 at level 1 reads out the junior connection information from the junior list management unit 340 and provides it to the voting-relay-type broker terminal 230 at level 2.

As a result, the voting-relay-type broker terminal 230 at level 2 terminates the connection to the relay-type broker terminal 220, and switches to the voting-type broker terminal 242 at level 3, which is at a child level relative thereto, at step S514. That is, when a flag value is compared with a predetermined threshold value and exceeds the threshold value, the level-down operation is performed on the transmission route.

Then, the voting-type broker terminal 242 stores the junior connection information received from the relay-type broker terminal 220 as senior connection information in the senior list management unit 420, and sets a new connection to the voting-relay-type broker terminal 232 of parent terminals at level 2, which has the highest transmission speed, based on the senior connection information at step S516.

As a result, the voting-type broker terminal 242 continuously and stably receives the multimedia stream through the voting-relay-type broker terminal 232 having the highest transmission speed.

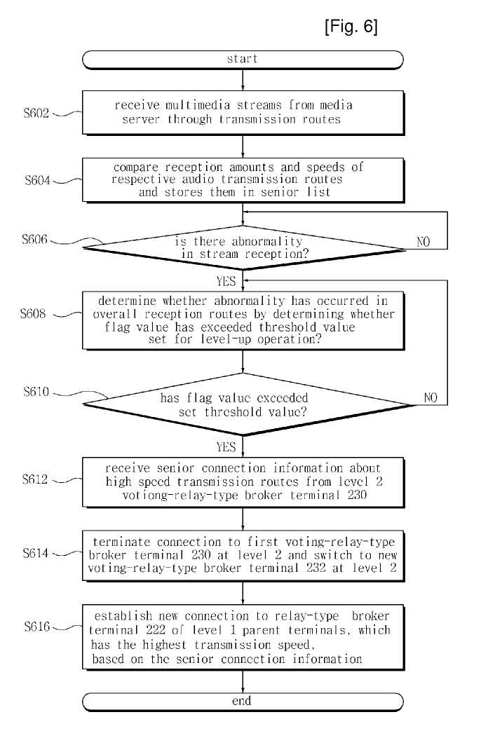

FIG. 6 is a flowchart illustrating a process of performing a level-up operation on a transmission route, in the method of voting an optimal route in multicasting, according to the embodiment of the present invention.

First, the term ‘level-up operation’ refers to a method of promoting the levels of transmission routes when an abnormality occurs in routes through which the voting-type broker terminal 240 at a child level receives a multimedia stream from the voting-relay-type broker terminal 230 at a senior parent level, and the number of routes having an abnormality is equal to or more than the half the number of all routes.

The voting-type broker terminal 240 at a child level receives a multimedia stream from the main server 210 through the relay-type broker terminal 220 and the voting-relay-type broker terminal 230 at a parent level at step S602.

When acting as a child terminal, the voting-type broker terminal 240 compares the reception amounts and transmission speeds of the respective audio transmission routes, through which substreams are received, with each other, and stores and manages the transmission routes in descending order of route quality in list form in a senior list management unit 420 at step S604.

Thereafter, the voting-type broker terminal 240 determines whether there is an abnormality, such as a disconnection or delay, during the reception of the multimedia stream at step S606.

If an abnormality occurs during the reception of the multimedia stream, the voting-type broker terminal 240 acquires latencies of all other audio transmission routes as well as a video stream transmission route and calculates the average of the latencies. Then the voting-type broker terminal 240 increases a flag value (upcount), determines whether the flag value has exceeded a predetermined threshold value, thereby determining whether the abnormality has occurred only in the senior parent terminal and itself, or in all reception routes, at step S608. At this time, when the average latency value is equal to or more than half the average transmission value of the all of the transmission routes, the connections of the overall reception routes through the voting-relay-type broker terminal 230 are considered to be undesirable.

If the flag value is increased, and is compared with and exceeds the predetermined threshold value at step S610, the voting-type broker terminal 240 at a child level receives senior connection information about transmission routes having high speed from the voting-relay-type broker terminal 230 at step S612. That is, the voting-relay-type broker terminal 230 at level 2 reads out the senior connection information from the senior list management unit 420 and provides it to the voting-type broker terminal 240 at level 3.

Therefore, the voting-type broker terminal 240 at level 3 terminates the connection to the first voting-relay-type broker terminal 230 at the parent level 2, and switches to the second voting-relay-type broker terminal 232 at parent level 2 relative thereto, at step S614.

Next, the new voting-relay-type broker terminal 232 sets up a new connection to the new relay-type broker terminal 222 that has the highest transmission speed among relay-type broker terminals at level 1, based on the senior connection information received from the prior relay-type broker terminal 220 at step S616.

As a result, the voting-type broker terminal 240 at the lowest child level is promoted to the voting-relay-type broker terminal 232 at the senior parent level. The voting-relay-type broker terminal 230, which has been at the child level relative to senior level 1, determines the relationship with the senior parent level, and then performs dynamic routing with the relay-type broker terminal 222.

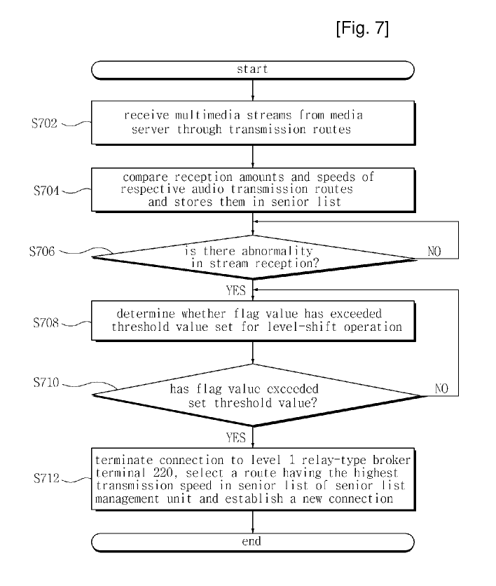

FIG. 7 is a flowchart illustrating a process of performing a level-shift operation on a transmission route, in the method of voting an optimal route in multicasting, according to the embodiment of the present invention.

First, the ‘level-shift’ operation is performed when conditions for the above-described level-down or level-up operation are not satisfied, and refers to a method of shifting a transmission route to a senior parent terminal when an abnormality, such as a disconnection or delay, occur in routes through which the voting-relay-type broker terminal 230 at a child level receives a multimedia stream from the first broker terminal 220 at a senior parent level. Therefore, the threshold value for the level shift operation is always smaller than the threshold value for the level-up or the level-down operation.

The voting-relay-type broker terminal 230 at a child level receives the multimedia streams from the main server 210 through the relay-type broker terminal 220 at a parent level. In detail, the voting-relay-type broker terminal 230 at a child level receives a video stream through the first relay-type broker terminal 220 and audio streams through the other relay-type broker terminals 222 to 228 at step S702.

The voting-relay-type broker terminal 230 at a child level compares the reception amounts and transmission speeds of the respective audio transmission routes, through which substreams are received, with each other and stores and manages the transmission routes in descending order of route quality in list form in the senior list management unit 420 at step S704.

Thereafter, the voting-relay-type broker terminal 230 determines whether there is an abnormality, such as a disconnection or delay, during the reception of the multimedia stream at step S706.

If an abnormality occurs during the reception of the multimedia stream, the voting-relay-type broker terminal 230 calculates the average latency of the video stream transmission route, increases a flag value, and determines whether the flag value has exceeded a predetermined threshold value for the level shift operation at step S708.

When determining whether the flag value has exceeded the predetermined threshold value for the level shift operation at step S710, the voting-relay-type broker terminal 230 at a child level terminates the connection to the relay-type broker terminal 220 at the parent level 1 and establishes a new connection by selecting the route having the highest transmission speed in the senior list at step S712.

As a result, if an abnormality occurs during the reception of the multimedia streams, the voting-relay-type broker terminal 230 calculates the average latency of a video transmission route, and increases the flag value. When the flag value exceeds the threshold value for the level shift operation, multimedia streams can be seamlessly and continuously received by shifting a parent terminal at the senior level and thus setting a new connection.

Furthermore, if the reception route of the multimedia stream is in a Network Address Translator (NAT) or firewall environment, the multimedia stream provided by the main server 210 is transmitted through TCP tunneling and the connection to the main server, that is, a central server, can be maintained. That is, the broker terminal having a public IP cannot directly connect to the broker terminal within the NAT, so that the public IP broker terminal requests a reverse connection by providing its own connection information to the main server 210. The main server 210 informs the broker terminal located within the NAT of the request for the reverse connection and delivers the connection information of the public IP broker terminal requesting the reverse connection. Thus, the broker terminal within the NAT connects to the public IP broker terminal using the connection information.

Meanwhile, when one audio transmission route switches to a video transmission route, a relay-type broker terminal or voting-type broker terminal adds one of the remaining reserved routes to an audio transmission route list to receive audio data. Accordingly, it is possible to rapidly receive a large amount of data in multimedia stream form by preparing an optimal relay candidate.

In accordance with the present invention, a method and system for voting an optimal route in multicasting can be implemented, which, when an abnormality, such as the delay or disconnection of a video stream, occurs during the reception of a predetermined or larger amount of multimedia data, which is multicast by a main server, in stream form, set the one among a plurality of audio transmission routes that has the highest transmission speed, as a video transmission route, and set the transmission route through a level-down, level-up, or level-shift operation depending on the latency values or threshold values of respective transmission routes, thus allowing a large amount of multimedia stream to be seamlessly and rapidly transmitted.

The above descriptions illustrates only the examples of the technical spirit of the present invention, and thus various amendments and modifications can be made by those skilled in the art without departing from the essential characteristics of the present invention.

Accordingly, the embodiments of the present invention are provided to illustrate the technical spirit of the present invention, not to limit the spirit thereof. Therefore, the technical spirit of the present invention is not limited by the embodiments.

The scope of the present invention must be interpreted by the accompanying claims, and the entire technical spirit falling within an equivalent range thereof must be considered as being included in the scope of the present invention.

What is claimed as new and desired to be protected by Letters Patent of the United States is:

1. A system for voting an optimal route, which most rapidly and stably receives multimedia streams multicast from a main server, comprising:
relay-type broker terminals for initially receiving the multimedia streams multicast from the main server and relaying them to terminals at a junior level;
voting-relay-type broker terminals for receiving a video stream from one relay-type broker terminal directly connected thereto and audio streams from remaining relay-type broker terminals, and, when an abnormality occurs in the reception route of the video stream, comparing reception amounts and transmission speeds of the respective audio transmission routes, voting a specific one of the audio transmission routes that has the highest speed, setting the voted route as a new video transmission route, and relaying the received multimedia streams to a terminal at a junior level; and
voting-type broker terminals for receiving the multimedia streams from the voting-relay-type broker terminals, receiving the video stream from one voting-relay-type broker terminal directly connected thereto and the audio streams from remaining voting-relay-type broker terminals, and when an abnormality occurs in the transmission route of the video stream, voting a specific one of the audio transmission routes that has the highest speed, setting the one as a new video transmission route, and receiving the video stream.

2. The system as set forth in claim 1, wherein each of the relay-type broker terminals comprises:
a connection information management unit for storing information about levels of targets to be connected and information about transmission speeds of current connections for transmitting multimedia streams;
a data transmission and reception control unit for processing various types of messages needed for data transmission and latency and functioning to control dynamic routing;
a media-channel management unit for managing connections for respective channels;
a junior list management unit for storing information about a list of routes through which multimedia streams are transmitted to the terminals at a junior level; and
a data transmission unit for transmitting the multimedia streams to an outside.

3. The system as set forth in claim 1, wherein each of the voting-relay-type broker terminals comprises:
a data reception unit for receiving the multimedia streams transmitted from the relay-type broker terminals;
a senior list management unit for storing transmission route list information for reception of multimedia streams from terminals at a senior level;
a connection information management unit for storing information about levels of targets to be connected and information about the transmission speeds of current connections for transmitting multimedia streams;
a data transmission and reception control unit for processing various types of messages needed for data transmission and latency and functioning to control dynamic routing;
a media-channel management unit for managing connections for respective channels;
a junior list management unit for storing information about a list of routes through which multimedia streams are transmitted to the terminals at a junior level; and
a data transmission unit for transmitting the multimedia streams to an outside.

4. The system as set forth in claim 1, wherein an audio transmission speed of the audio transmission route is calculated using the following Equation:
packet size*256/(current time-packet transmission time)/the total number of child terminals.

5. The system as set forth in claim 1, wherein an optimal route voting program is installed in the relay-type broker terminals, the voting-relay-type broker terminals, and the voting-type broker terminals.

6. The system as set forth in claim 3, wherein, at a time of a new connection, the junior list management unit and the senior list management unit compare a speed of the new connection with speeds of existing connections, arrange the transmission speeds in descending order, and update the list of routes.

7. The system as set forth in claim 3, wherein, when a connection delay or disconnection occurs during reception of the multimedia stream, the data reception unit reads out an uppermost value having a highest speed, from the current list of the senior list management unit, sets a corresponding route as a transmission route and, for the transmission route set as a connection route, decreases a speed value by half, and updates the candidate list.

8. The system as set forth in claim 6, wherein, if the reception routes of the multimedia streams are in a Network Address Translator (NAT) or firewall environment, the multimedia streams provided by the main server are transmitted through TCP tunneling, and connection to the main server, that is, a central server, is maintained.

9. A method of voting an optimal route in a system having voting-relay-type broker terminals for receiving multimedia streams from a main server through relay-type broker terminals and relaying the multimedia streams to a terminal at a junior level, and voting-type broker terminals for receiving the multimedia streams relayed by the voting-relay-type broker terminals, comprising:
a first step of receiving the multimedia streams comprising video and audio from the main server through transmission routes;
a second step of comparing reception amounts and transmission speeds of respective audio transmission routes and storing the transmission routes in senior list and junior list;
a third step of determining whether an abnormality, including a delay or disconnection, has occurred in reception of a video stream;
a fourth step of calculating an average latency value of the video transmission route, increasing a flag value and determining whether the flag value has exceeded a predetermined threshold value; and
a fifth step of, if the flag value has exceeded the predetermined threshold value, comparing reception amounts and transmission speeds of respective audio transmission routes, voting a route having the highest transmission speed and setting the voted route as a video stream reception route.

10. The method as set forth in claim 9, wherein, if, as a result of the determination at the fourth step, an abnormality has occurred in a single transmission route between the voting-relay-type broker terminal and the relay-type broker terminal on the basis of the voting-relay-type broker terminal, the voting-relay-type broker terminal receives junior connection information for transmission routes having high speed from the relay-type broker terminal, terminates a connection to the relay-type broker terminal, switches to a voting-type broker terminal at a junior level and sets a new connection to another voting-relay-type broker terminal having the highest transmission speed based on senior connection information with the junior connection information set to the senior connection information, thereby performing a level-down operation on the transmission route.

11. The method as set forth in claim 9, wherein, if, as a result of the determination at the fourth step, an abnormality has occurred in overall transmission routes between the voting-relay-type broker terminal and the voting-type broker terminal when the voting-type broker terminal receives the multimedia streams through the voting-relay-type broker terminal, the voting-type broker terminal receives senior connection information from the voting-relay-type broker terminal, terminates a connection to the voting-relay-type broker terminal based on the senior connection information, switches to another voting-relay-type broker terminal, and sets a new connection to another relay-type broker terminal having the highest transmission speed, thereby performing a level-up operation on the transmission route.

12. The method as set forth in claim 9, wherein, if, as a result of the determination at the fourth step, an abnormality has occurred in transmission routes between the voting-relay-type broker terminal and the relay-type broker terminal, rather than in a single transmission route or in all transmission routes, on the basis on the basis of the voting-relay-type broker terminal, the voting-relay-type broker terminal terminates a connection to the relay-type broker terminal, selects a route having the highest transmission speed in a senior list of the senior list management unit and sets a new connection to another corresponding relay-type broker terminal, thereby performing a level-shift operation on the transmission route.

13. The method as set forth in claim 9, wherein an audio transmission speed of the audio transmission route is calculated using the following Equation:
packet size*256/(current time-packet transmission time)/the total number of child terminals.

14. The method as set forth in claim 9, wherein, if reception routes of the multimedia streams are in a NAT or firewall environment, the multimedia streams provided by the main server are transmitted through TCP tunneling and connection to the main server, that is, a central server, is maintained.

15. The method as set forth in claim 9, wherein the transmission route list is updated by decreasing a transmission speed value by half for the transmission route set as a connection route.

16. The method as set forth in claim 9, wherein the relay-type broker terminals, the voting-relay-type broker terminals and the voting-type broker terminal respectively communicate with a multicasting relay program, which is installed in the main server, through a plurality of multicasting routers using a program for performing a relay function, and receive the multimedia streams provided from the main server.
